(19) United States
(12) Patent Application Publication
(10) Pub. No.: US 2019/0040547 A1
(43) Pub. Date: Feb. 7, 2019

(54) MULTI-ROW MELT-BLOWN FIBER SPINNERET

(71) Applicant: AMTEK RESEARCH INTERNATIONAL LLC, Lebanon, OR (US)

(72) Inventors: Craig Allen Benjamin, Lebanon, OR (US); Chi Thuong-Le La, Happy Valley, OR (US); Matthew Alan Warren, Salem, OR (US)

(21) Appl. No.: 16/077,419

(22) PCT Filed: Feb. 28, 2017
(86) PCT No.: PCT/US2017/020037

§ 371 Date: Aug. 10, 2018

Related U.S. Application Data
(60) Provisional application No. 62/301,423, filed on Feb. 29, 2016.

(51) Int. Cl. D01D 4/02

(52) U.S. Cl. CPC D01D 4/025; B05C 11/1044

(57) ABSTRACT

A multi-row melt-blown fiber spinneret (8) enables stacking rows (12₁, 12₂, 12₃) of polymer outlet orifices (36) more closely together than is achievable with conventional melt-blown fiber spinnerets. The fiber spinneret configuration also enables dense side-by-side packing of the polymer outlet orifices. The fiber spinneret is configured so that air knife channels (14_{1c}, 14_{2c}, 14_{3c}, 14_{4c}) and individual intricate small air knife passage feeds, together with their associated melt flow channels (50₁, 50₂, 50₃), are formed in the same body member. The rows of polymer outlet orifices are supplied with a polymer melt by a single polymer inlet (20), which delivers the polymer melt to the individual polymer melt flow channels. The air knife channels are directed through the body member, in which the polymer melt flow channels are formed by islands and air flow passage feeds. The body member is constructed by operation of a 3D printer for direct metal printing.

### COPYRIGHT NOTICE

© 2017 Amtek Research International LLC. A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR § 1.71(e).

### TECHNICAL FIELD

This disclosure relates to melt-blowing thermoplastic materials to make nonwoven fibrous forms and, in particular, to a melt-blown fiber spinneret that includes a body member formed by 3D printing and having, along its width, multiple closely spaced rows of polymer outlet orifices from which streams of polymer fiber melt filaments emerge to form a nonwoven fibrous mat at high throughput.

### BACKGROUND INFORMATION

U.S. Pat. No. 3,825,380 describes a conventional so-called Exxon style melt-blown die head in which a nose configuration approximating a triangle in cross section is suitable for use in a melt-blowing process for making fibers from thermoplastic materials. The junction of two exterior surfaces of the triangle forms, at its apex, a truncated edge through which a row of die openings is machined. Air channels are machined in the die head on either side of each die opening. Melt channels terminating in the die openings are supplied with thermoplastic resin from a distribution manifold with individual inputs to each row of die openings. Thermoplastic resin is forced out of the row of die openings in the die head and into an air stream supplied through the air channels to attenuate the thermoplastic resin and thereby form very fine fibers.

Stacking the Exxon style melt-blown die heads to construct multiple rows of die openings necessitates provision of separate thermoplastic resin inlets above and below each row of die openings. This resin inlet arrangement accommodates the cross air stream flow through the air channels on either side of each die opening in the row of die openings. The impact of this configuration is a constraint on a minimum distance between adjacent rows that is set by the diameters of the air cross-holes supplying the air stream to the air channels. A distance of less than about 12.7 mm (0.5 in.) between adjacent rows would be difficult to achieve using conventional machining methods.

### SUMMARY OF THE DISCLOSURE

A multi-row melt-blown fiber spinneret enables stacking rows of polymer outlet orifices more closely together than is achievable with conventional melt-blown fiber spinneret designs. The melt-blown fiber spinneret is configured so that gas knife channels and individual intricate small gas knife passage feeds, together with their associated polymer melt flow channels, are formed in the same body member. A preferred gas is an inert gas, air, atmosphere, or other form of gas with a high viscosity after being heated to a desired temperature. The description below refers to process air for use as a preferred gas, which is defined as atmospheric air conditioned by an air compressor or blower system, heated to a preferred temperature of between about 150 ° C. to about 300 ° C. or higher, and delivered to a plenum attached to spinneret 8. The melt-blown fiber spinneret configuration also enables dense side-by-side packing of the polymer outlet orifices in each of the stacked rows of them.

In preferred embodiments, the multiple rows of polymer outlet orifices are supplied with a polymer melt by a single polymer inlet, which delivers the polymer melt to individual polymer melt flow channels within the body member of the melt-blown fiber spinneret. Air knife channels are directed through the body member, in which the polymer melt flow channels are formed by means of islands and air flow passage feeds. All of the components and features are contained within a very small footprint, thereby enabling row center-to-row center separation of 6.35 mm (0.25 in.) or smaller.

The melt-blown fiber spinneret is preferably a unitary or multiple component article, with the body member constructed by operation of a 3D printer for direct metal printing.

Additional aspects and advantages will be apparent from the following detailed description of preferred embodiments, which proceeds with reference to the accompanying drawings.

### BRIEF DESCRIPTION OF THE DRAWINGS

FIGS. 1A and 1B are respective frontal and rear isometric views of an embodiment of a melt-blown fiber spinneret constructed in accordance with the present disclosure.

FIGS. 2, 3, and 4 are respective rear elevation, top plan, and enlarged frontal elevation views of the fiber spinneret of FIGS. 1A and 1B.

FIG. 5 is an enlarged sectional view taken along lines B-B of FIG. 4.

FIG. 6 is an enlarged sectional view taken along lines C-C of FIG. 4.

FIG. 7 is a side view of a body member of the melt-blown fiber spinneret of FIGS. 1A and 1B, showing in broken lines the various fluid flow channels and passage feeds depicted in the three sectional views presented as FIGS. 8, 9, and 10.

FIG. 8 is a sectional view taken along lines A-A of FIG. 7.

FIG. 9 is a sectional view taken along lines D-D of FIG. 7.

FIG. 10 is a sectional view taken along lines E-E of FIG. 7.

FIG. 11 is a fragmentary isometric frontal view of the fiber spinneret of FIGS. 1A and 1B, in which notch portions A and B are removed to illustrate the spatial relationship of the air passage feeds shown in FIGS. 5, 6, and 7.

FIG. 12 is a copy of FIG. 5, with the addition of bevels to the air knife channels of the body member of the fiber spinneret shown in FIGS. 1A and 1B.

FIG. 13A is an isometric view and FIG. 13B is a copy of FIG. 12 showing an air knife deflector plate mounted on the body member of the fiber spinneret of FIGS. 1A and 1B.

FIG. 14A is an isometric view and FIG. 14B is a cross-sectional view of an alternative embodiment of the disclosed fiber spinneret, in which a fluid outlet component containing the polymer outlet orifices is a separate component that is attached to the body member of the fiber spinneret.

FIGS. 15A is a diagram showing the air flow patterns produced without an air knife deflector plate mounted to the body member of the fiber spinneret of FIG. 12, and FIG. 15B is a diagram showing the air flow patterns produced with an air knife deflector plate mounted to the body member of the fiber spinneret of FIG. 14B.

FIG. 16 shows, as an alternative embodiment, a body member that implements air knives formed by two converging air knife channels that run on either side of polymer melt flow channels along the length of the body member.

### DETAILED DESCRIPTION OF PREFERRED EMBODIMENTS

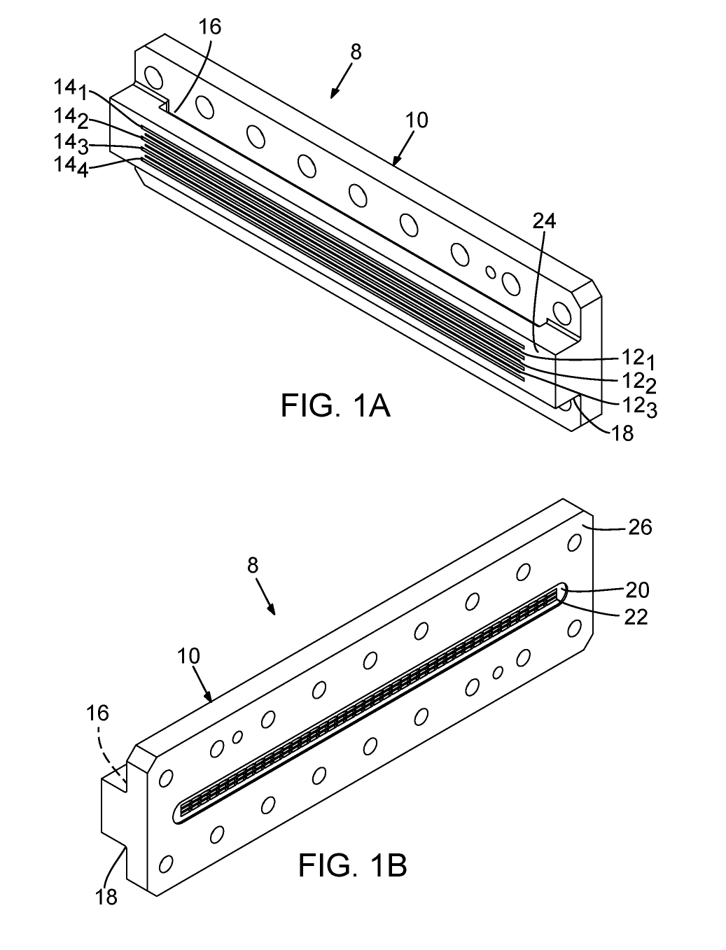

FIGS. 1A and 1B are respective frontal and rear isometric views of a melt-blown fiber spinneret 8 (hereafter “fiber spinneret 8”) that includes a body member 10 having on its front side three rows 12₁, 12₂, and 12₃ of polymer outlet orifices positioned between different pairs of four air knives 14₁, 14₂, 14₃, and 14₄. Body member 10 has an upper air inlet 16 and a lower air inlet 18 into each of which hot air (i.e., 150° C.-300° C. or higher) is delivered from an external process air supply (not shown). Body member 10 has on its rear side a polymer inlet pocket 20 that receives a screen 22 through which thermoplastic fiber-forming material, such as polymer material in melt form, enters. The front side and rear side of body member 10 have a polymer melt outlet surface 24 and a polymer melt inlet surface 26, respectively.

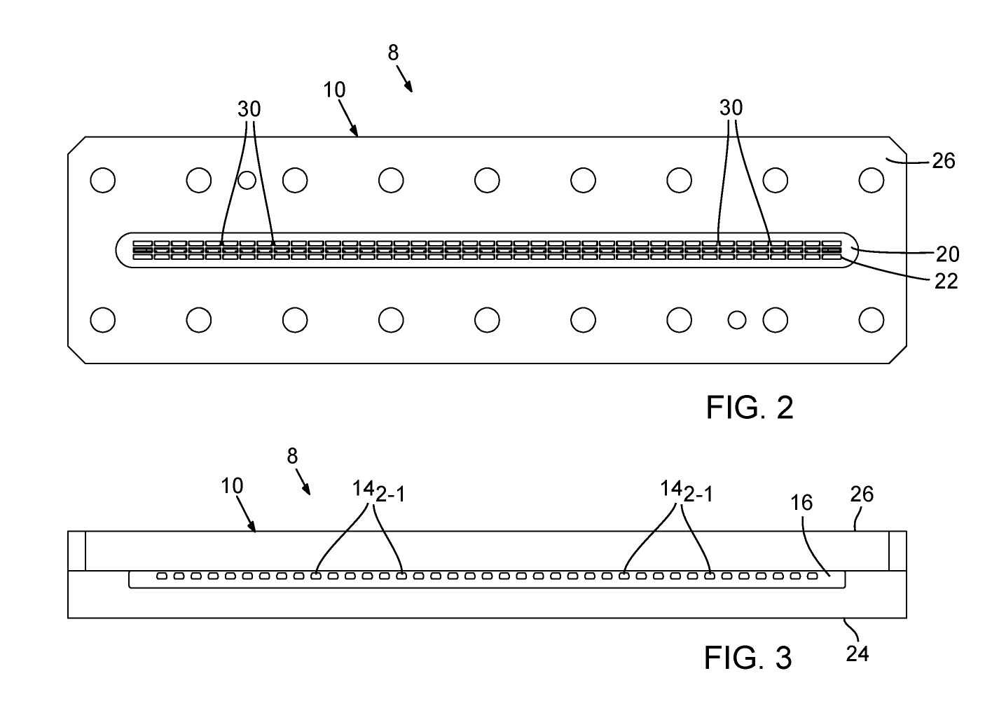

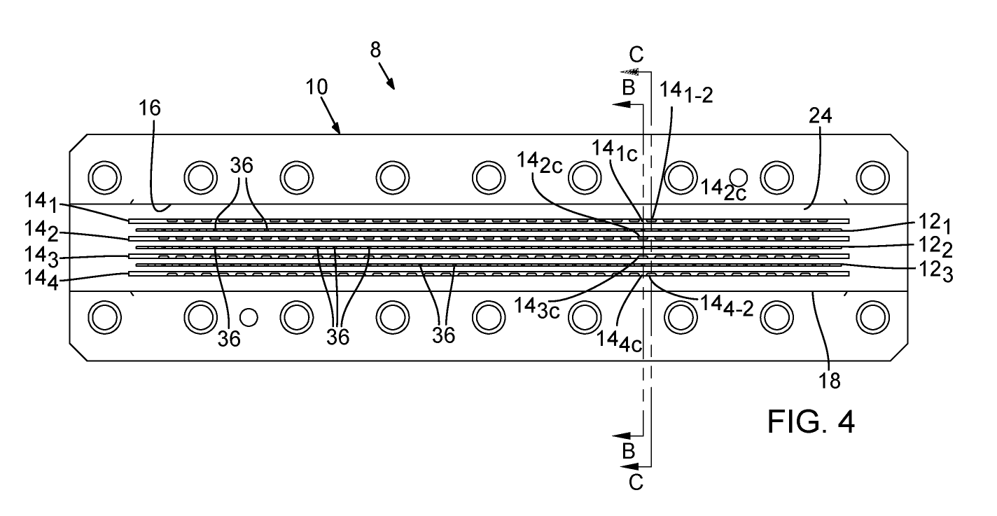

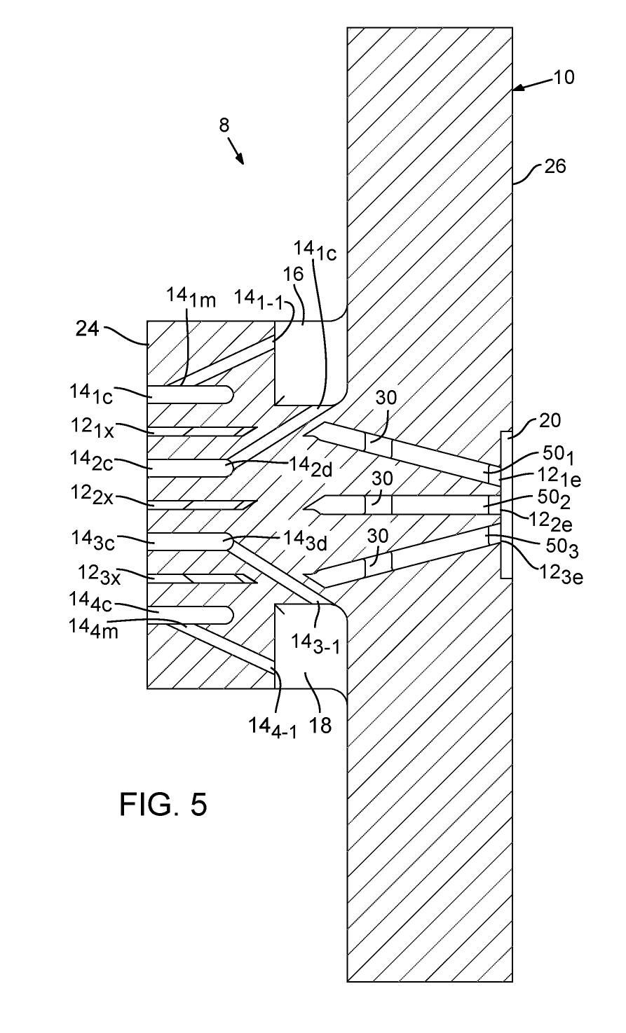

FIGS. 2, 3, and 4 are respective rear elevation, top plan, and frontal elevation views of body member 10. FIG. 2 shows polymer channel support islands 30 that act as a breaker plate (i.e., support) for screen 22. FIG. 3 shows upper air inlet 16 to air knives 14₁, 14₂, 14₃, and 14₄. Lower air inlet 18 is of the same design configuration as that of upper air inlet 16. FIG. 4 shows the arrangement of rows 12₁, 12₂, and 12₃ of polymer outlet orifices 36 positioned between the different pairs of air knives 14₁, 14₂, 14₃, and 14₄.

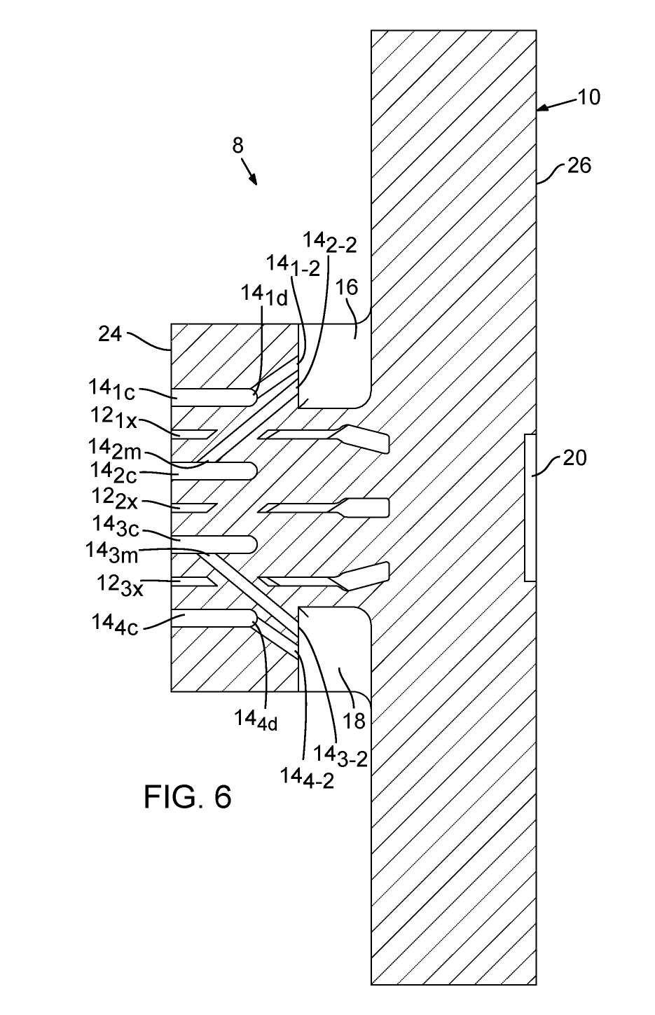

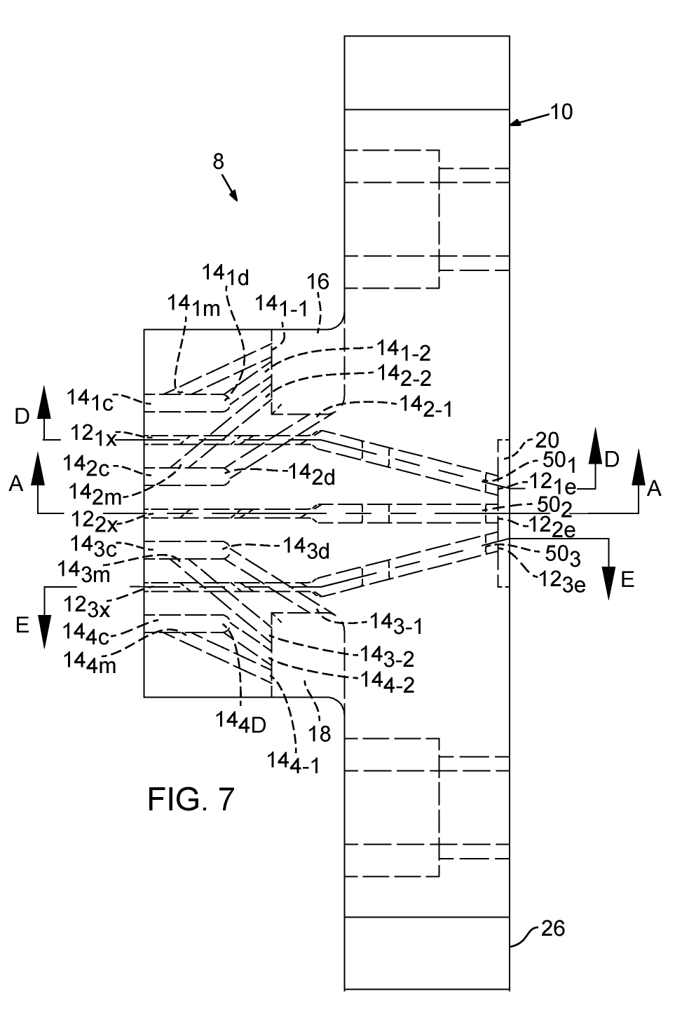

FIGS. 5 and 6 are sectional views taken along, respectively, lines B-B and lines C-C of FIG. 4. FIG. 5 shows a polymer flow channel 12₁ with a polymer melt entrance end 12₁ₑ and exit end 12₁ₓ, a polymer flow channel 12₂ with a polymer melt entrance end 12₂ₑ and exit end 12₂ₓ, and a polymer flow channel 12₃ with a polymer melt entrance end 12₃ₑ and exit end 12₃ₓ. FIGS. 5 and 6 present cross-sectional views taken at different locations along the width of body member 10 to show the positioning of air passage feeds to air knife channels for each one of two sets of air knife channel configurations of air knives 14₁, 14₂, 14₃, and 14₄. The two sets of air knife channel configurations are grouped in an alternate sequence along rows 12₁, 12₂, and 12₃ of polymer outlet orifices 36.

With reference to FIG. 5, an air knife channel 14₁, receives from upper air inlet 16 hot process air flow through an air passage feed 14₁₋₁ that is connected to a medial opening 14₁ₘ in air knife channel 14₁, of air knife 14₁. Similarly, an air knife channel 14₄, receives from lower air inlet 18 hot process air flow through an air passage feed 14₄₋₁ that is connected to medial opening 14₄ₘ in air knife channel 14_{4c} of air knife 14₄. An air knife channel 14_{2c} receives from upper air inlet 16 hot process air flow through an air passage feed 14₂₋₁ that is connected to a distal opening 14_{2d} in air knife channel 14_{2c} of air knife 14₂. Similarly, an air knife channel 14_{3c} receives from lower air inlet 18 hot process air flow through an air passage feed 14₃₋₁ that is connected to a distal opening 14_{3d} in air knife channel 14₃, of air knife 14₃.

With reference to FIG. 6, an air knife channel 14₁, receives from upper air inlet 16 hot process air flow through an air passage feed 14₁₋₂ that is connected to a distal opening 14_{1d} in air knife channel 14₁, of air knife 14₁. Similarly, an air knife channel 14₄, receives from lower air inlet 18 hot process air flow through an air passage feed 14₄₋₂ that is connected to distal opening 14_{4d} in air knife channel 14₄, of air knife 14₄. An air knife channel 14_{2c} receives from upper air inlet 16 hot process air flow through an air passage feed 14₂₋₂ that is connected to a medial opening 14₂ₘ in air knife channel 14_{2c} of air knife 14₂. Similarly, an air knife channel 14₃, receives from lower air inlet 18 hot process air flow through an air passage feed 14₃₋₂ that is connected to a medial opening 14₃ₘ in air knife channel 14₃, of air knife 14₃. Although they exhibit a straight line profile in FIGS. 5 and 6, the air passage feeds to the air knife channels may be formed in a curved profile in body member 10.

The cross-sectional views of FIGS. 5 and 6 show polymer melt flow channels 50₁, 50₂, and 50₃ that form polymer flow passageways from polymer inlet pocket 20 to the three stacked polymer outlet orifices 36 of rows 12₁, 12₂, and 12₃, respectively. FIGS. 5 and 6 show that the two sets of air knife channels grouped in an alternating sequence are configured so that connections of the pairs of air passage feeds to outermost-positioned air knife channels of air knives 14₁ and 14₄ and the pairs of air passage feeds to the middle-positioned air knife channels of air knives 14₂ and 14₃ alternate between medial and distal openings to their respective air knife channels along rows 12₁, 12₂, and 12₃ of polymer outlet orifices 36. The configuration of alternating pairs of air knife passage feeds enables closer spacing and thereby more densely side-by-side packing of polymer outlet orifices 36 of the stacked rows 12₁, 12₂, and 12₃. The large number of air passage feeds in a staggered pattern of them across the width of fiber spinneret 8 results in a reduced concentration of air flowing from the individual air passage feeds at the air knife outlet. The spacing between adjacent polymer outlet orifices 36 achievable with this configuration is 0.64 mm (0.025 in.), which facilitates provision of 401 polymer outlet orifices 36 for each of rows 12₁, 12₂, and 12₃ of a 25.4 cm (10 in.) wide fiber spinneret 8.

Close polymer die orifice spacing of up to about 2 orifices/mm (50 holes/in.) is achievable using 3D printing techniques to form a unitary body member 10 made of a nickel-chromium alloy such as Inconel® alloy 718 material or 17-4PH stainless steel. A suitable 3D printer for direct metal printing is a Trumpf TruPrint Series 1000 3D printing system, available from Trumpf Laser-und Systemtechnik, Ditzingen, Germany. Each of polymer outlet orifices 36 formed by 3D printing is finish reamed to size, which is 0.254 mm (0.010 in.) diameter specification. This process reduces greatly the cost as compared to that of drilling holes conventionally.

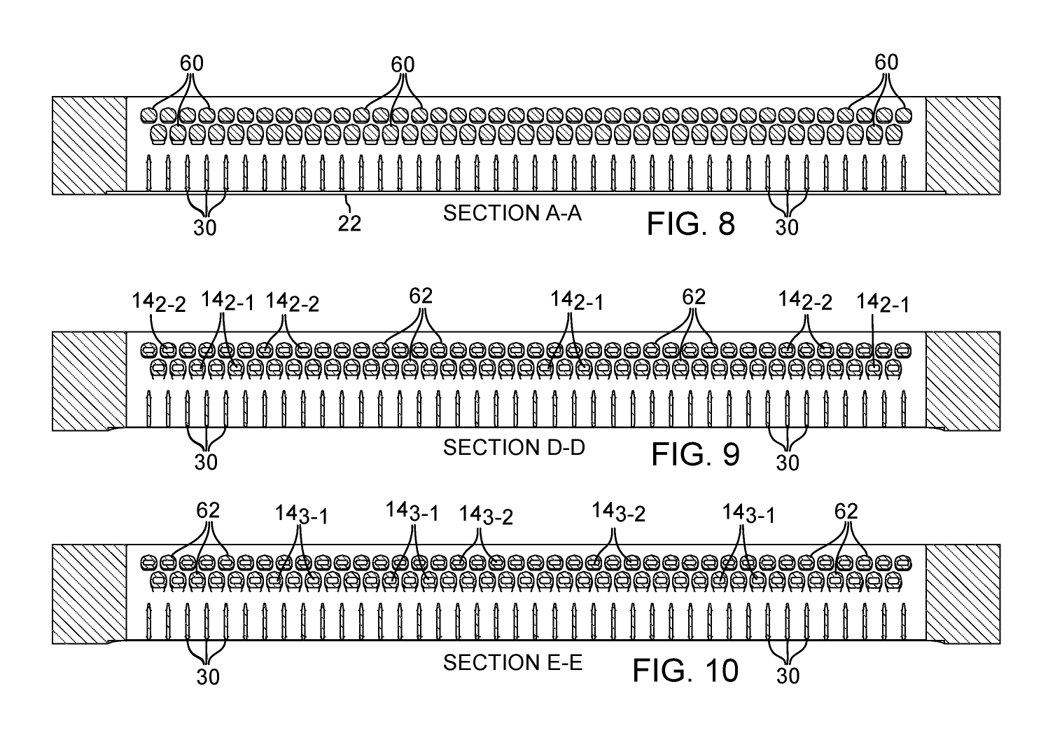

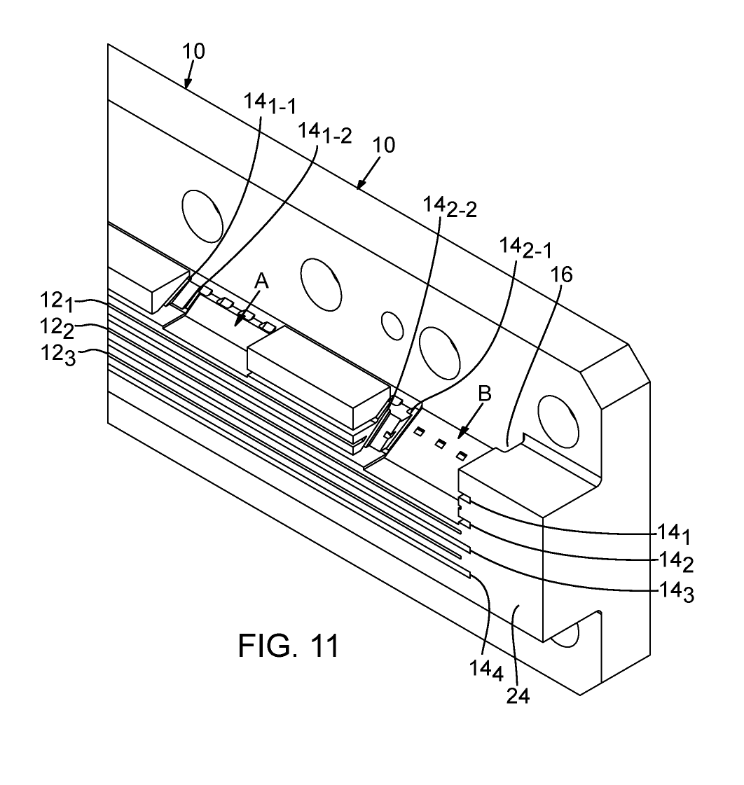

FIG. 7 is a side view of body member 10 of fiber spinneret 8, showing in broken lines polymer melt flow channels 12₁, 12₂, and 12₃, together with the two sets of air knife channels and their associated air passage feeds of air knives 14₁, 14₂, 14₃, and 14₄, for use in reference to FIGS. 8, 9, and 10. FIGS. 8, 9, and 10 are sectional views taken along, respectively, lines A-A, D-D, and E-E of FIG. 7. FIG. 8 is a cross-sectional view taken through each of polymer outlet orifices 36 of middle row 12₂ to show polymer channel islands 60 positioned to balance polymer flow to upper melt flow inlet channels 50₁ and lower melt flow inlet channels 50₃. Channel islands 60 do not provide material for passage of air. Channel islands 60 contain no air passage because their presence in middle polymer melt flow channel 12₂ is for the purpose of balancing the backpressure in the polymer melt flow channels. This balancing of backpressure helps to balance the polymer flow velocity of rows 12₁, 12₂, and 12₃ of polymer outlet orifices 36.

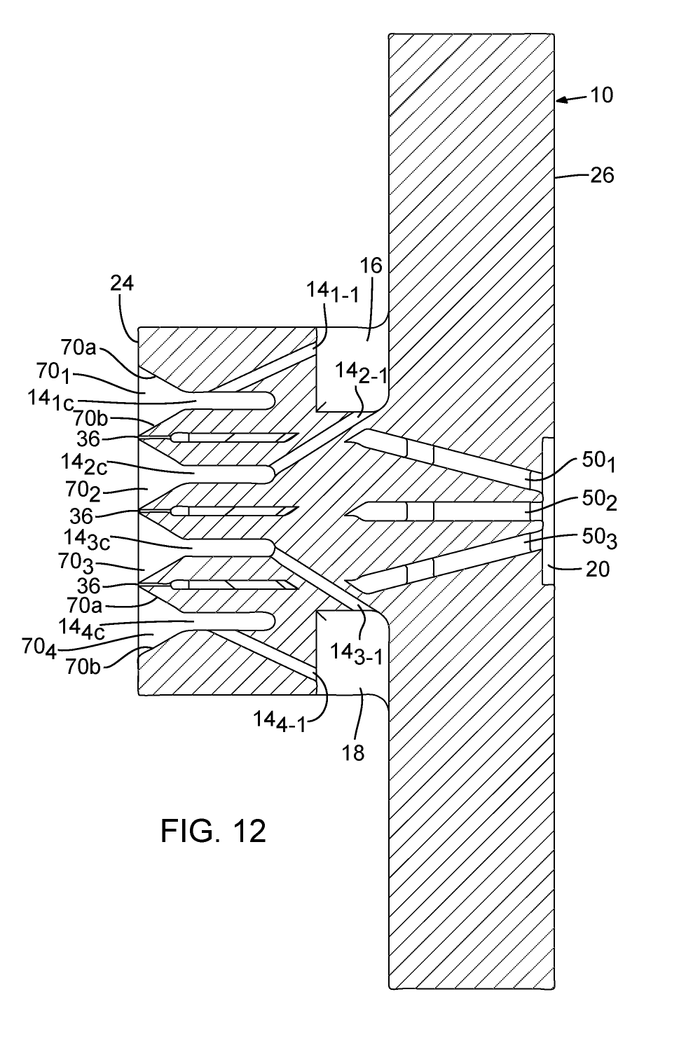

FIG. 9 is a cross-sectional view taken through each of polymer outlet orifices 36 of row 12₁ and upper melt flow inlet channel 50₁ to show the air passageway of air knife 14₂ and islands 62 in upper melt flow inlet channel 50₁ that provide location for air passage.

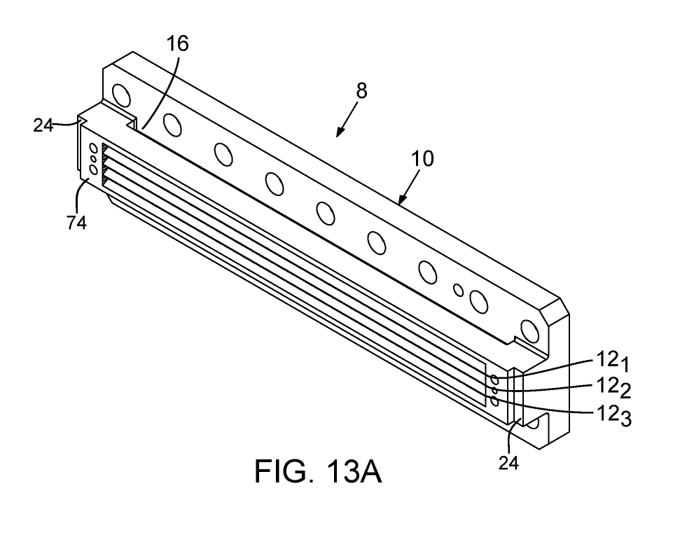

FIG. 10 is a cross-sectional view taken through each of polymer outlet orifices 36 of row 12₃ and lower melt flow inlet channel 50₃ to show the air passageway of air knife 14₃ and islands 62 in lower melt flow inlet channel 50₃ that provide location for air passage.

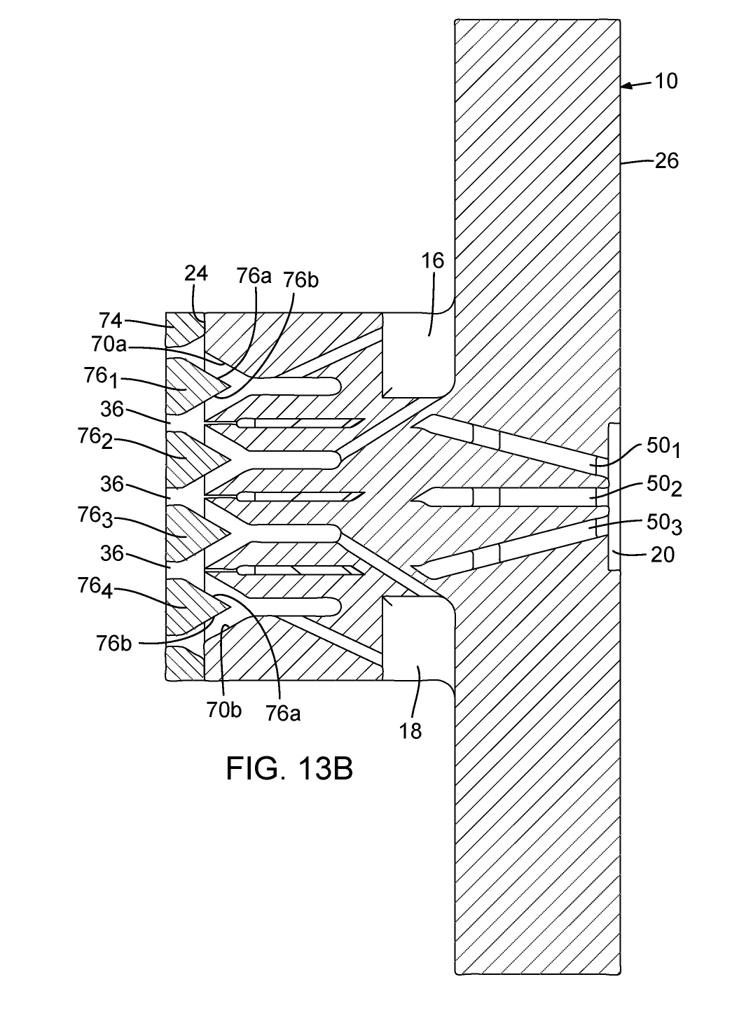

FIG. 11 is a fragmentary isometric frontal view of body member 10, in which notch portions A and B are removed to illustrate the spatial relationship of the air passage feeds shown in and described with reference to FIGS. 5, 6, and 7. Specifically, notch portions A and B reveal air passage feeds 14₁₋₁ and 14₁₋₂ of air knife 14₁ and air passage feeds 14₂₋₂ and 14₂₋₁ of air knife 14₂, respectively, on either side of row 12₁ of polymer outlet orifices 36.

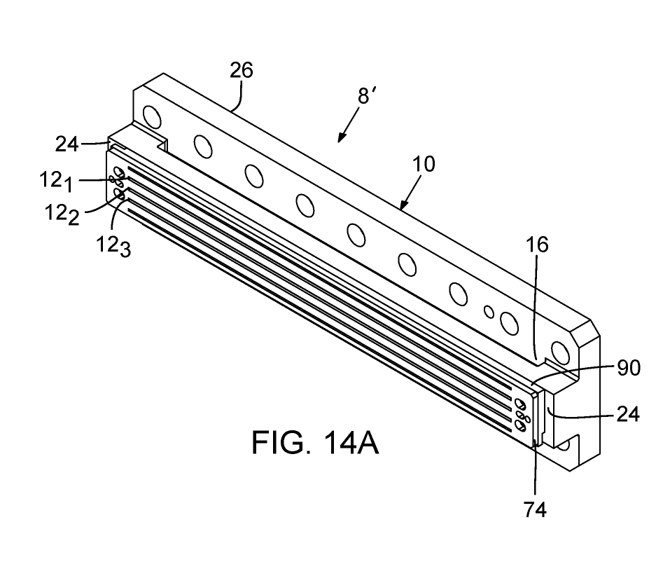

FIG. 12 is a copy of FIG. 5, with the addition of bevels 70₁, 70₂, 70₃, and 70₄ (collectively, bevels 70) to, respectively, air knife channels 14_{1c}, 14_{2c}, 14_{3c}, and 14_{4c} at polymer melt outlet surface 24 of body member 10. Each of bevels 70 has sides 70a and 70b that diverge in the direction toward polymer melt outlet surface 24 to form angled gas channel nozzles.

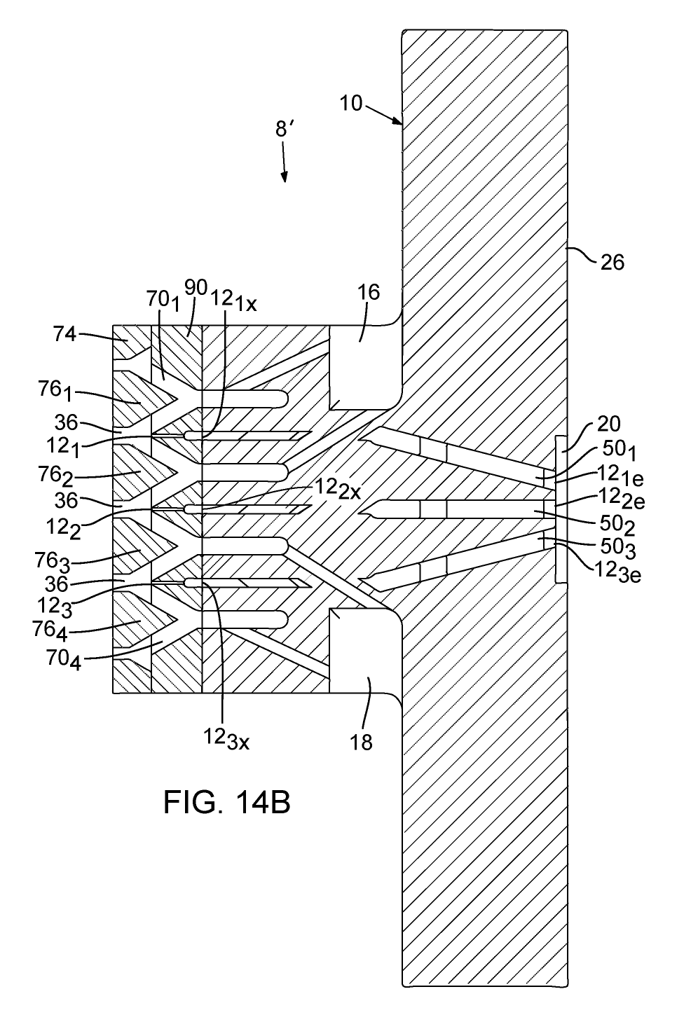

FIG. 13A is an isometric view and FIG. 13B is a copy of FIG. 12 showing an air knife deflector component or plate 74 mounted on polymer melt outlet surface 24 of body member 10. Air knife deflector plate 74 is preferably a separate article that is not an integral part of body member 10. Air knife deflector plate 74 can be produced as a separate component part by either 3D printing or other fabrication methods. Air knife deflector plate 74 includes truncated substantially rhombus-shaped air deflection features 76₁, 76₂, 76₃, and 76₄ (collectively, air deflection features 76).

Each of air deflection features 76 has sides 76a and 76b that converge to an apex. Air deflection features 76 fit within spatially aligned bevels 70, with confronting sides 76a and 70a spaced apart from each other and confronting sides 76b and 70b spaced apart from each other. The complementary shapes of, and spaces between, air deflection features 76 and bevels 70 direct flow of air inwardly toward the polymer fiber melt filament emerging from polymer outlet orifices 36. Specifically, the air space between side 76b of air deflection feature 76₁ and side 70b of bevel 70₁, and the air space between side 76a of air deflection feature 76₂ and side 70a of bevel 70₂ form angled air knives 14₁ and 14₂ directing air flow toward either side of a polymer fiber melt filament emerging from a polymer outlet orifice in row 12₁. The air space between side 76b of air deflection feature 76₂ and side 70b of bevel 70₂, and the air space between side 76a of air deflection feature 76₃ and side 70a of bevel 70₃ form angled air knives 14₂ and 14₃ directing air flow toward either side of a polymer fiber melt filament emerging from a polymer outlet orifice in row 12₂. The air space between side 76b of air deflection feature 76₃ and side 70b of bevel 70₃, and the air space between side 76a of air deflection feature 76₄ and side 70a of bevel 70₄ form angled air knives 14₃ and 14₄ directing air flow toward either side of a polymer fiber melt filament emerging from a polymer outlet orifice in row 12₃.

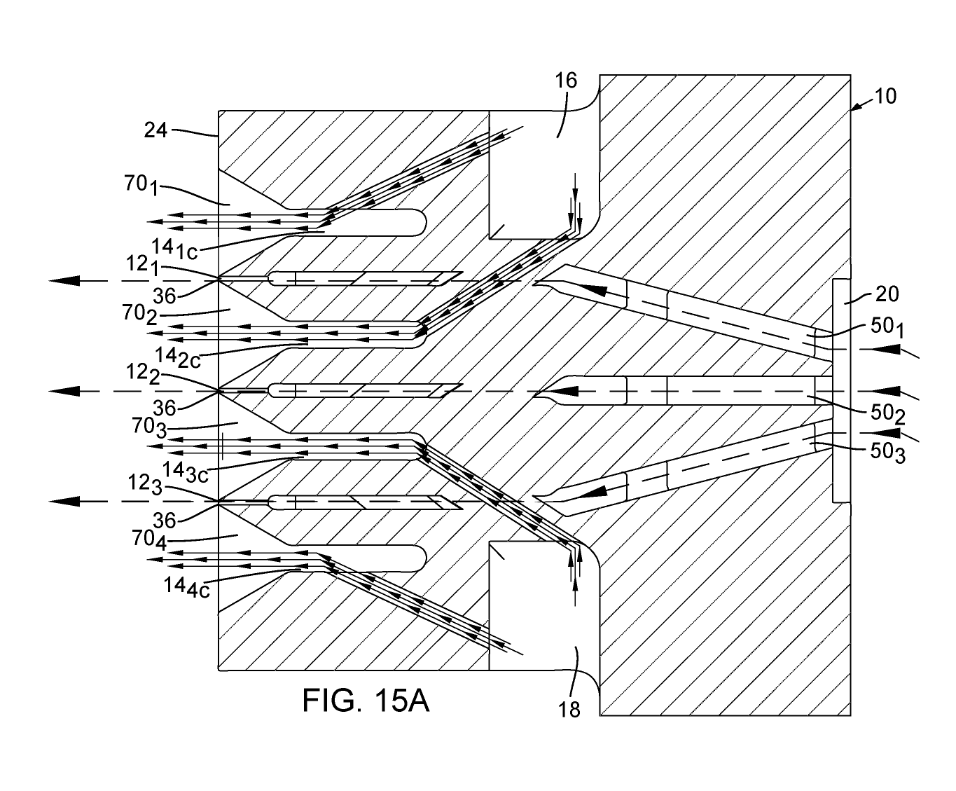

FIGS. 14A and 14B show an alternative melt-blown fiber spinneret 8′, in which a fluid outlet component 90 containing polymer outlet orifices 36 is mounted to polymer melt outlet surface 24 of body member 10. Output orifices 36 of fluid outlet component 90 are spatially aligned with polymer melt exit ends 12₁ₓ, 12₂ₓ, and 12₃ₓ of corresponding polymer flow channels 50₁, 50₂, and 50₃. Bevels 70₁, 70₂, 70₃, and 70₄ are positioned in fluid outlet component 90 and receive the respective air deflection features 76₁, 76₂, 76₃, and 76₄ of air knife deflector plate 74 that is mounted to fluid outlet component 90. The use of fluid outlet component 90 with polymer outlet orifices 36 separate from body member 10 reduces the cost of spinneret 8′ by facilitating reconfiguration of fiber spinneret 8′ without entirely reconstructing it.

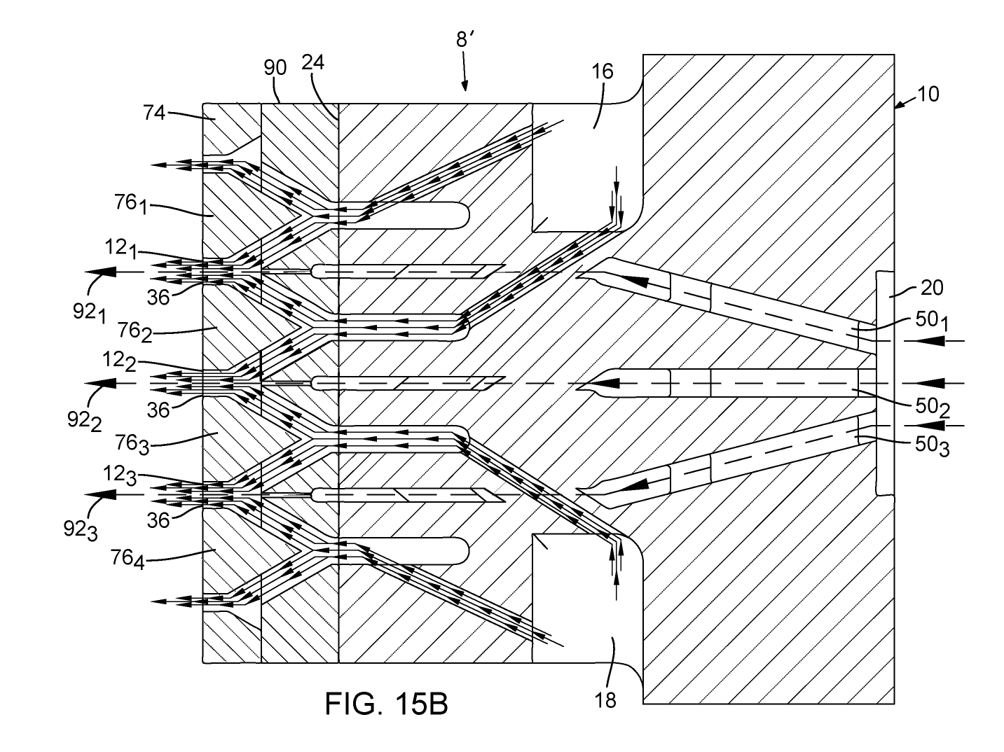

FIGS. 15A and 15B are two diagrams showing the air flow patterns produced, respectively, without and with use of air knife deflector plate 74. FIG. 15A shows the directions of air flow developed by air knife channels 14₁, 14_{2c}, 14_{3c}, and 14₄, in the absence of air knife deflector plate 74, as shown in FIG. 12. The air flow is parallel to the polymer fiber streams as they emerge from polymer outlet orifices 36 of rows 12₁, 12₂, and 12₃. FIG. 15B shows the directions of air flow developed by angled air knives 14₁, 14₂, 14₃, and 14₄, resulting from attachment of air knife deflector plate 74 to fluid outlet component 90, as shown in FIG. 14B. The air flow pinches (i.e., converges inwardly toward) the streams of polymer fiber melt filaments 92₁, 92₂, 93₃ as they emerge from the respective polymer outlet orifices 36 of rows 12₁, 12₂, and 12₃ to facilitate attenuation of the polymer fibers formed.

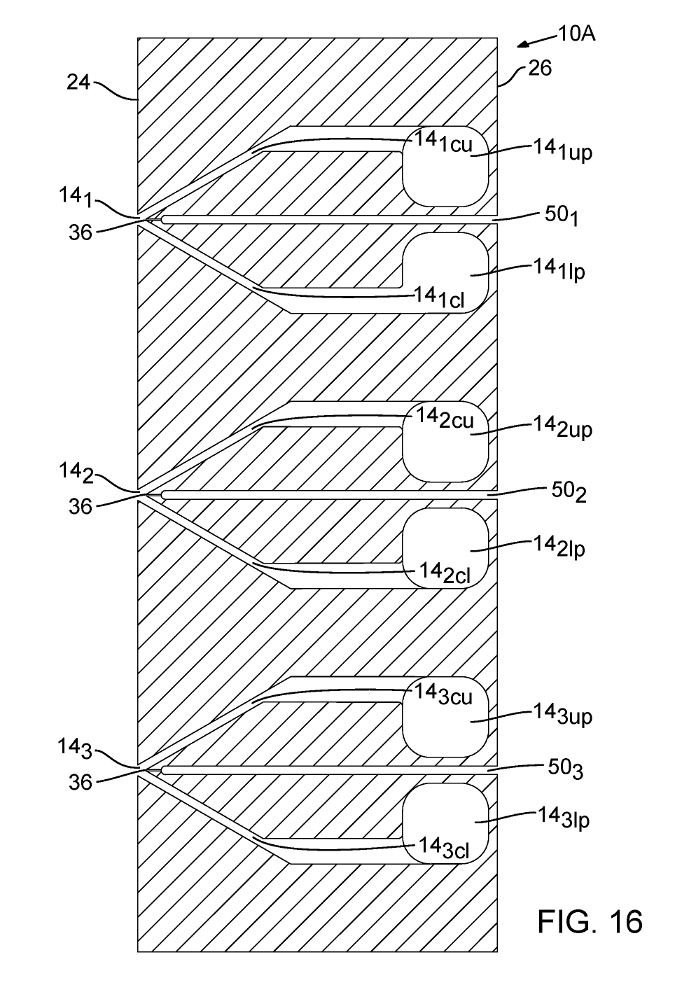

FIG. 16 shows a body member 10A, which is an alternative embodiment that implements air knives 14₁, 14₂, and 14₃ formed by two converging air knife channels that run on either side of polymer melt flow channels 50₁, 50₂, and 50₃ along the length of body member 10A. Air knife 14₁ is formed by air knife channels 14₁and 14_{1c1} that are supplied by air plenums 14₁ᵤₚ and 14₁ₗₚ, air knife 14₂ is formed by air knife channels 14₂,, and 14_{2cl} that are supplied by air plenums 14₂ᵤₚ and 14₂ₗₚ, and air knife 14₃ is formed by air knife channels 14₃and 14_{cl} that are supplied by air plenums 14₃ᵤₚ and 14₃ₗₚ. For each air knife, the two air plenums receive process air from a single port (not shown) located at polymer melt inlet surface 26.

It will be obvious to those having skill in the art that many changes may be made to the details of the above-described embodiments without departing from the underlying principles of the invention. For example, a multi-polymer inlet could be used for making a bi- or tri-component fibrous nonwoven mat. The scope of the invention should, therefore, be determined only with reference to the following claims.

1. A melt-blown fiber spinneret including polymer outlet orifices from which polymer fiber melt filaments emerge, comprising:
a body member including a polymer melt inlet surface and a polymer melt outlet surface;
multiple polymer melt flow channels formed in the body member, each of the multiple polymer melt flow channels having a polymer melt entrance end in fluid communication with the polymer inlet surface and a polymer melt exit end in fluid communication with the polymer outlet surface;
multiple gas knife channels formed in the body member and in fluid communication with the polymer outlet surface;
multiple gas passage feeds formed in the body member and connected to different ones of the multiple gas knife channels, each of the multiple gas passage feeds having a gas passage feed entrance end in fluid communication with a gas supply to deliver gas flow to the gas knife channel to which the gas passage feed is connected; and
different pairs of the multiple gas knife channels configured to deliver, at the polymer melt outlet surface, the gas flow along opposite sides of each one of the polymer melt flow channels.

2. The melt-blown fiber spinneret of claim 1, further comprising:
a fluid outlet component operatively coupled to the polymer melt outlet surface of the body member, the fluid outlet component including multiple polymer outlet orifices spatially aligned with the polymer melt exit ends of corresponding ones of the multiple polymer melt flow channels and from which multiple polymer melt streams flow; and
multiple angled gas channel nozzles spatially aligned with corresponding ones of the multiple gas knife channels from which the gas flow emanates.

3. The melt-blown fiber spinneret of claim 2, further comprising a gas knife deflector component operatively coupled to the fluid outlet component and including multiple gas deflection features that are spatially aligned with corresponding ones of the multiple angled gas channel nozzles, the multiple gas deflection features configured to direct the gas flow out of the multiple angled gas channel nozzles toward the polymer melt streams flowing out of the multiple polymer melt flow channels to attenuate the streams of polymer melt and thereby cause emergence of polymer fiber melt filaments from the multiple polymer outlet orifices.

4. The melt-blown fiber spinneret of claim 1, in which the polymer melt exit ends of the multiple polymer melt flow channels terminate in corresponding ones of multiple polymer outlet orifices from which multiple polymer melt streams flow, and in which the multiple gas knife channels terminate in corresponding ones of multiple angled gas channel nozzles formed at the polymer melt outlet surface of the body member to direct the gas flow out of the angled gas channel nozzles along the opposite sides of the polymer melt flow channels from which the multiple polymer melt streams flow.

5. The melt-blown fiber spinneret of claim 4, further comprising a gas knife deflector component operatively coupled to the polymer melt outlet surface of the body member and including multiple gas deflection features that are spatially aligned with corresponding ones of the multiple angled gas channel nozzles, the multiple gas deflection features configured to direct the gas flow out of the multiple angled gas channel nozzles toward the polymer melt streams flowing out of the multiple polymer flow outlet orifices to attenuate the streams of polymer melt and thereby cause production of polymer fiber melt filaments from the multiple polymer outlet orifices.

6. The melt-blown fiber spinneret of claim 1, in which the body member, including the multiple polymer melt flow channels, multiple gas knife channels, and multiple gas passage feeds formed in the body member, are in the form of a unitary article constructed by operation of a 3D printer.

7. The melt-blown fiber spinneret of claim 1, in which the polymer outlet orifices are mutually spaced apart by less than about 0.64 mm.

8. The melt-blown fiber spinneret of claim 1, in which the gas supply is process air.

9. The melt-blown fiber spinneret of claim 1, in which the polymer outlet orifices are arranged in multiple rows extending along a width of the body member, and in which the gas knife channels are grouped in alternate sets of knife channel configurations along the rows of polymer outlet orifices.

10. The melt-blown fiber spinneret of claim 9, in which the alternate sets of knife channel configurations include different connection positions of the gas passage feeds to the gas knife channels to which the gas passage feeds are connected.

11. The melt-blown fiber spinneret of claim 1, in which the polymer outlet orifices are formed in the body member by operation of a 3D printer and thereafter finish reamed to size.
